(19) United States
(12) Patent Application Publication
(10) Pub. No.: US 2026/0184083 A1
(43) Pub. Date: Jul. 2, 2026

(54) LIQUID CARTRIDGE

(71) Applicant: BROTHER KOGYO KABUSHIKI KAISHA, Nagoya (JP)

(72) Inventors: Masahiro HAYASHI, Anjo (JP); Hiroaki TAKAHASHI, Nagoya (JP); Satoru OKI, Nagoya (JP); Fumio NAKAZAWA, Okazaki (JP); Fumiya NAKAMURA, Nagoya (JP); Yuji FUKUTA, Nagoya (JP); Yuki TAKAMATSU, Nagoya (JP); Naoya OKAZAKI, Hashima (JP)

(73) Assignee: BROTHER KOGYO KABUSHIKI KAISHA, Nagoya (JP)

(21) Appl. No.: 19/433,169

(22) Filed: Dec. 26, 2025

(30) Foreign Application Priority Data
Dec. 27, 2024 (JP) 2024-231506

(51) Int. Cl. B41J 2/175

(52) U.S. Cl. CPC B41J 2/17556; B41J 2/17523; B41J 2/17553; B41J 2/17596

(57) ABSTRACT

A liquid cartridge inserted into a printer includes a housing and a first valve mechanism. The housing has a first cylindrical portion that opens in a frontward. At least portion of the first valve mechanism is accommodated within the first cylindrical portion. The first valve mechanism includes a first seal member, a first valve, and a first biasing member. The first seal member is in contact with an inner peripheral surface of the first cylindrical portion. The first seal member having a first through hole. The first valve is positioned inside the first cylindrical portion. The first valve is movable between a closed position and an open position. The first biasing member biases the first valve frontward such that the first valve biases toward the closed position.

### REFERENCE TO RELATED APPLICATIONS

This application claims priority from Japanese Patent Application No. 2024-231506 filed on Dec. 27, 2024. The entire content of the priority application is incorporated herein by reference.

### BACKGROUND ART

An ink refill container in which ink is stored is known. Such ink refill container includes a check valve arranged at an ink supply port. The check valve has a piston to which a sealing material attached. The piston is movable between an open position that opens the ink supply port and a closed position that closes the ink supply port.

### SUMMARY

For example, in an ink refill container, when the temperature inside the ink refill container rises, the pressure inside the ink refill container also increases. Due to the pressure increase, the sealing material deforms. As a result, the ink inside the ink refill container is more likely to leak out through the ink supply port.

In view of the foregoing, it is an object of the present disclosure to provide a liquid cartridge that is less likely to leak liquid from inside a casing to an outside.

In order to attain the above and other object, the present disclosure provides a liquid cartridge configured to be inserted into a printer. The liquid cartridge includes: a housing having a first cylindrical portion that opens in a frontward, toward which the liquid cartridge is inserted in a front-rear direction; and a first valve mechanism, at least portion of the first valve mechanism being accommodated within the first cylindrical portion. The first valve mechanism includes: a first seal member being in contact with an inner peripheral surface of the first cylindrical portion and, the first seal member having a first through hole; a first valve being positioned inside the first cylindrical portion and the first valve being movable between a closed position at which the first valve closes the first through hole and an open position at which the first valve opens the first through hole; a first biasing member biasing the first valve frontward such that the first valve biases toward the closed position; and a first cap having an annular shape and the first cap being attached to the first cylindrical portion. The first cap has a first inclined surface having an annular shape. The first inclined surface is in contact with the first seal member from the frontward. The first inclined surface is inclined with respect to a direction perpendicular to the front-rear direction such that the first inclined surface is positioned frontward in the front-rear direction as the first inclined surface is positioned outward in the direction perpendicular to the front-rear direction.

In the above structure, for example, an increase in the temperature inside the housing may cause the pressure inside the housing to rise. At this time, a force pushing the first seal member frontward acts on the first seal member, causing the first seal member to deform and potentially allowing liquid inside the housing to leak out through the opening of the first cylinder portion. In the above configuration, the first inclined surface of the first cap is in contact with the first seal member from the front. Therefore, when a force pushing the first seal member frontward acts on the first seal member, a force pressing the first seal member against the inner peripheral surface of the first cylinder portion from the first inclined surface acts on the first seal member. As a result, the first seal member firmly adheres to the inner peripheral surface of the first cylinder portion, suppressing leakage of liquid from the opening of the first cylinder portion to the outside through the space between the inner peripheral surface of the first cylinder portion and the outer peripheral surface of the first seal member.

### BRIEF DESCRIPTION OF DRAWINGS

FIG. 1 is a schematic vertical cross-sectional view showing an internal structure of printer 10.

FIG. 2 is an enlarged view of the surroundings including an ink cartridge 30 shown in FIG. 1.

FIG. 3 is a perspective view of the ink cartridge 30 viewed from the front and above.

FIG. 4 is a perspective view of the ink cartridge 30 viewed from the rear and below.

FIG. 5 is an enlarged cross-sectional view of the surrounding area including an upper valve mechanism 504.

FIG. 6 is an enlarged cross-sectional view of the surrounding area including a lower valve mechanism 12.

FIG. 7 is a perspective view of a lower cap 39 as seen from the rear and above.

FIG. 8 is a perspective view of the lower cap 39 as seen from the front and above.

FIG. 9 is an enlarged perspective view of an upper support member 38 as seen from the rear and above.

FIG. 10 is a perspective view of the upper support member 38 as seen from the front and above.

FIG. 11 is a cross-sectional view of the upper seal member 17, cut along a plane including a virtual straight line passing through the center of an upper seal member 17.

FIG. 12 is a perspective view of an upper cap 55 as seen from the rear and above.

FIG. 13 is a cross-sectional view of the upper cap 55 cut by a plane containing a virtual line passing through the center of the upper cap 55.

FIG. 14 is a cross-sectional view of the ink cartridge 30 in the ink injection posture where ink is injected into the ink cartridge 30.

FIG. 15 is a schematic diagram showing the upper support member 38 partially inserted into the internal space of an atmospheric communication section 502.

FIG. 16 is a cross-sectional view of the upper seal member 17 according to a modification example.

### DESCRIPTION

For example, in an ink refill container, when the temperature inside the ink refill container rises, the pressure inside the ink refill container also increases. Due to the pressure increase, the sealing material deforms. As a result, the ink inside the ink refill container is more likely to leak out through the ink supply port.

In view of the foregoing, it is an object of the present disclosure to provide a liquid cartridge that is less likely to leak liquid from inside a casing to an outside.

The present disclosure provides a liquid cartridge configured to be inserted into a printer. The liquid cartridge includes: a housing having a first cylindrical portion that opens in a frontward, toward which the liquid cartridge is inserted in a front-rear direction; and a first valve mechanism, at least portion of the first valve mechanism being accommodated within the first cylindrical portion. The first valve mechanism includes: a first seal member being in contact with an inner peripheral surface of the first cylindrical portion and, the first seal member having a first through hole; a first valve being positioned inside the first cylindrical portion and the first valve being movable between a closed position at which the first valve closes the first through hole and an open position at which the first valve opens the first through hole; a first biasing member biasing the first valve frontward such that the first valve biases toward the closed position; and a first cap having an annular shape and the first cap being attached to the first cylindrical portion. The first cap has a first inclined surface having an annular shape. The first inclined surface is in contact with the first seal member from the frontward. The first inclined surface is inclined with respect to a direction perpendicular to the front-rear direction such that the first inclined surface is positioned frontward in the front-rear direction as the first inclined surface is positioned outward in the direction perpendicular to the front-rear direction.

For example, an increase in the temperature inside the housing may cause the pressure inside the housing to rise. At this time, a force pushing the first seal member frontward acts on the first seal member, causing the first seal member to deform and potentially allowing liquid inside the housing to leak out through the opening of the first cylinder portion. In the above configuration, the first inclined surface of the first cap is in contact with the first seal member from the front. Therefore, when a force pushing the first seal member frontward acts on the first seal member, a force pressing the first seal member against the inner peripheral surface of the first cylinder portion from the first inclined surface acts on the first seal member. As a result, the first seal member firmly adheres to the inner peripheral surface of the first cylinder portion, suppressing leakage of liquid from the opening of the first cylinder portion to the outside through the space between the inner peripheral surface of the first cylinder portion and the outer peripheral surface of the first seal member.

The first seal member has a second inclined surface being in contact with the first seal member from a rearward. The second inclined surface is inclined with respect to the direction perpendicular to the front-rear direction such that the second inclined surface is positioned frontward in the front-rear direction as the second inclined surface is positioned outward in the direction perpendicular to the front-rear direction.

The second inclined surface of the first seal member easily receives force from the first inclined surface in the direction of pressing the first seal member against the inner peripheral surface of the first cylindrical portion. For this reason, the first seal member adheres more firmly to the inner peripheral surface of the first cylindrical portion.

The first cap has a first surface positioned inward, which is opposite to the outward, with respect to the first inclined surface. The first surface faces rearward and the first surface is in contact with the first seal member from the frontward. The first seal member has a second surface positioned inward with respect to the second inclined surface. The second surface faces frontward and the second surface is in contact with the first surface.

The first cap includes: a first cap body having an annular shape and the first cap body being welded to the inner peripheral surface of the first cylindrical portion; and a first rib extending from the first cap body rearward in the front-rear direction, and the first inclined surface being positioned at a rear end of the first rib. An outer peripheral surface of the first rib and the inner peripheral surface of the first cylindrical portion define a gap therebetween.

The melted portion that has dissolved due to the welding of the first cap body flows into the gap. Therefore, when the first cap body is welded to the inner peripheral surface of the first cylindrical portion, the deformation of the first cap is suppressed.

The first seal member includes: a seal body having an annual shape and defining the first through hole; and a first contact portion having an annual shape, the first contact portion extending outward from an outer peripheral surface of the seal body, and the first contact portion being in contact with the inner peripheral surface of the first cylindrical portion. The rear end of the first rib is in contact with a front surface of the first contact portion from the frontward.

The melted portion that flows into the gap due to the welding of the first cap body is trapped in the gap, making it difficult for it to overflow inside the first cap through the space between the rear end of the first rib and the front surface of the first contact portion. Additionally, even if liquid leaks into the gap through the space between the outer peripheral surface of the first contact portion and the inner peripheral surface of the first cylindrical portion, the liquid that has leaked into the gap is unlikely to flow out inside the cap through the space between the rear end of the first rib and the front surface of the first contact portion. As a result, leakage of liquid from inside the housing to the outside through the opening of the first cylindrical portion is suppressed.

The first valve mechanism further includes a support member having an annual shape, the support member extending in the front-rear direction within the first cylindrical portion, and the support member accommodates the first valve and the first biasing member. The support member has a second contact portion being in contact with a rear portion of the first contact portion in the front-rear direction.

By having the second contact portion engage the first contact portion from the rear, the first seal member is positioned in the front-rear direction. This makes it easier to assemble the first valve mechanism to the first cylindrical portion.

The support member has a plurality of second ribs extending inward from a front end of an inner peripheral surface of the support member and positioned at equal intervals in a circumferential direction of the support member. The plurality of second ribs are in contact with a rear end of the first seal member and an outer peripheral surface of the first valve.

The multiple second ribs uniformly contact the rear surface of the first seal member around the circumference of the support member. This makes it difficult for the first seal member to tilt, thereby preventing liquid inside the housing from leaking through the opening of the first cylindrical portion. Since the multiple second ribs are positioned at equal intervals around the circumference of the support member, a flow path for air to flow in the front-rear direction is ensured within the support member. The first valve is less likely to be inclined.

The first biasing member is a coil spring compressible in the front-rear direction. The support member has a plurality of third ribs positioned rearward of the plurality of second ribs, each of the plurality of the third ribs extending inward from the inner peripheral surface of the support member, and the plurality of the third ribs being positioned at equal intervals in the circumferential direction of the support member. The plurality of third ribs are in contact with an outer peripheral surface of the coil spring.

The coil spring is guided in the front-back direction by multiple third ribs, making it resistant to tilting. Therefore, the first valve, which is biased by the coil spring, is less likely to tilt, allowing it to move smoothly in the front-back direction between the closed and open positions.

The inner peripheral surface of the first cylindrical portion has an annular stepped surface sloped inward in the front-rear direction as the stepped surface extends rearward. The support member has an annular outer rib protruding outward from an outer peripheral surface of the support member. A rear surface of the outer rib is inclined in a direction orthogonal to the front-rear direction so as to face rearward as the rear surface of the outer rib extends inward and the rear surface is in contact with the stepped surface.

The support member is positioned in the front-rear direction by the rear surface of the outer rib contacting the stepped surface of the first cylindrical part. The rear surface of the outer rib and the stepped surface of the first cylindrical part contact each other at an angle relative to the front-rear direction. Because of this, ink inside the liquid cartridge is less likely to leak forward through the space between the rear surface of the outer rib and the stepped surface of the first cylindrical part.

The support member connects an internal space of the support member and an outside, and the support member has a slit that extends in the front-rear direction.

For example, liquid is injected into the housing through a second cylindrical section that connects the inside and outside of the housing. At this time, even if bubbles form on the liquid surface, they tend to disappear upon contact with the slit. As a result, printing defects caused by bubbles being sent to the printer's discharge head are suppressed.

In a state where the first cylindrical portion opens upwardly, a lower end of the slit is positioned below a maximum liquid level inside the housing when a maximum amount of liquid is injected.

In the injection posture where the opening of the first cylindrical section faces upward, for example, liquid is injected into the housing through the second cylindrical section that connects the inside and outside of the housing. At this time, bubbles formed on the liquid surface come into contact with the slit as the liquid surface rises due to the injection, causing the bubbles to disappear more reliably.

The slit includes three slits positioned at equal intervals in the circumferential direction of the support member.

For example, when the housing is formed by blow molding, a blow pin that blows air into the internal space of the parison clamped by the mold is screwed in. As a result, excess material may accumulate on the inner peripheral surface of the first cylindrical section. In the above configuration, the three slits allow avoidance of the excess material, making it easier to insert the support member into the first cylindrical section through the opening of the first cylindrical section.

The present disclosure further provides a liquid cartridge configured to be inserted into a printer. The liquid cartridge a housing and a second valve mechanism. The housing has a second cylindrical portion that opens in a frontward, toward which the liquid cartridge is inserted in a front-rear direction. At least portion of the second valve mechanism being accommodated within the second cylindrical portion. The second valve mechanism includes a second seal member, a seal valve, a second biasing member, and a second cap. The second seal member is in contact with an inner peripheral surface of the second cylindrical portion and having a second through hole. The seal valve is positioned inside the second cylindrical portion and movable between a closed position at which the second valve closes the second through hole and an open position at which the second valve opens the second through hole. The second biasing member biases the second valve frontward such that the second valve moves toward the closed position. The second cap is attached to the second cylindrical portion, positioned the frontward of the second seal member in the front-rear direction, and in contact with an inner peripheral surface of the second seal member.

For example, an increase in temperature inside the housing can cause the pressure inside the housing to rise. At this time, a force pushing the second seal member forward may act on it, potentially causing the second seal member to shift backward in the front-to-back direction. As a result, the second valve may fail to fully close the second through-hole in the closed position, allowing liquid inside the housing to leak out from the opening of the second cylinder portion. In the above configuration, the second cap positioned in front of the second seal member comes into contact with the inner peripheral surface of the second seal member, causing the second seal member to firmly adhere to the inner peripheral surface of the second cylinder portion. Therefore, the position of the second seal member in the front-to-back direction is less likely to shift backward, suppressing the leakage of liquid inside the housing from the opening of the second cylinder portion to the outside.

The second cap includes a second cap body, a third contact portion, and a plurality of connecting pieces. The second cap body has an annual shape and the second cap body being welded to the inner peripheral surface of the second cylindrical portion. The third contact portion positioned backward of the second cap body in the front-rear direction and the third contact portion being in contact with the second sealing member. The plurality of connecting pieces connecting the second cap body and the third contact portion in the front-rear direction and the plurality of connecting pieces being positioned at intervals in a circumferential direction of the second cap.

The melted portion released by the welding of the second welded part flows into the gap between the connecting pieces adjacent in the circumferential direction of the second cap. Therefore, when the second welded part is welded to the inner peripheral surface of the second cylindrical part, the deformation of the second cap is significantly suppressed.

According to this disclosure, the liquid inside the enclosure is less likely to leak outside.

The following describes embodiments of the present disclosure. Note that the embodiments described below are merely examples in which the present disclosure is embodied, and the embodiments can be appropriately modified without changing the gist of the present disclosure.

The following describes embodiments of the present disclosure. Note that the embodiments described below are merely examples in which the present disclosure is embodied, and the embodiments can be appropriately modified without changing the gist of the present disclosure.

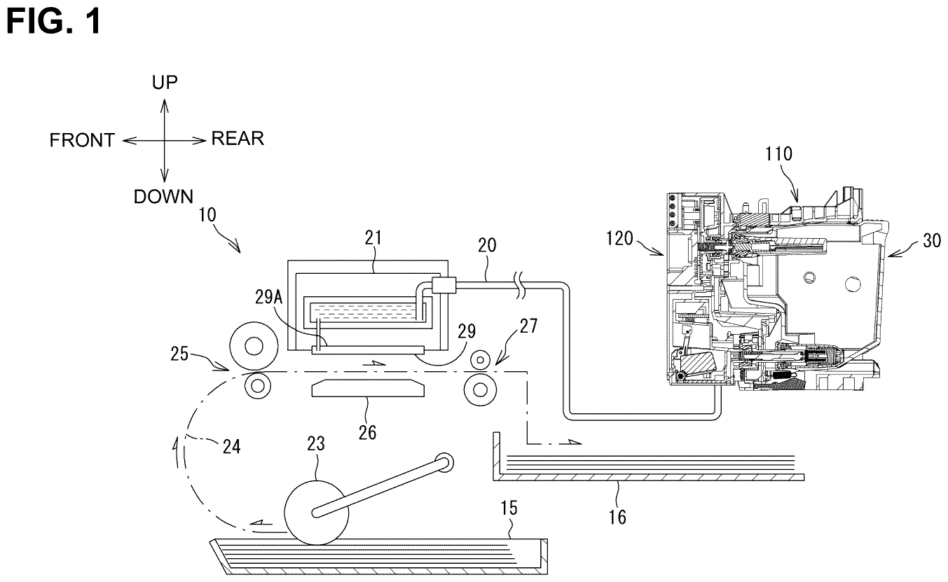

As shown in FIG. 1, an ink cartridge 30 can be inserted into a cartridge case 110 of a printer 10. Hereinafter, the direction in which the ink cartridge 30 is inserted into the cartridge case 110 is referred to as the front. The opposite direction to the front is referred to as the rear. That is, the direction in which the ink cartridge 30 is removed from the cartridge case 110 is referred to as the rear. The front and rear directions together are referred to as the front-rear direction. In the mounted posture where the ink cartridge 30 is installed in the cartridge case 110, the vertical direction of the ink cartridge 30 is defined. When viewing the ink cartridge 30 in the mounted posture from the front, the left-right direction is defined.

### [Overview of Printer 10]

The printer 10 includes a cartridge case 110, a sub-tank 120, an ink tube 20, a recording head 21, and an ink cartridge 30. The printer 10 is an inkjet recording device that records images by ejecting ink droplets from the recording head 21 onto paper based on an inkjet recording method. The printer 10 is, for example, an inkjet printer.

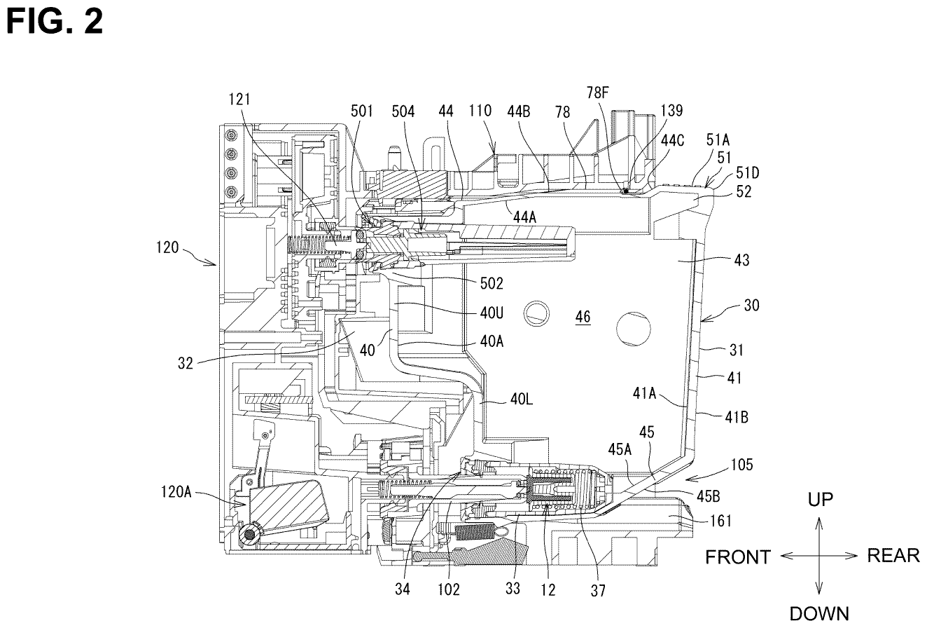

The ink cartridge 30 is installed in cartridge case 110. As shown in FIG. 2, the cartridge case 110 has an opening 105 at the rear end. The ink cartridge 30 is inserted frontward into the internal space of cartridge case 110 through the opening 105. The ink cartridge 30 is pulled backward out of the cartridge case 110 through the opening 105. FIG. 2 shows the installed posture of the ink cartridge 30 when it is fully installed in the cartridge case 110.

The ink cartridge 30 stores ink that can be used in the printer 10. The ink cartridge 30 may also store a processing liquid containing additives for improving image quality. When the ink cartridge 30 is fully installed in the cartridge case 110, the ink cartridge 30 is connected to the recording head 21 via an ink tube 20. The recording head 21 ejects the ink supplied from the ink cartridge 30 through multiple nozzles 29. Ink is an example of a liquid.

As shown in FIG. 1, the printer 10 includes a paper feed tray 15, a paper feed roller 23, a pair of transport rollers 25, a platen 26, a pair of discharge rollers 27, and a paper discharge tray 16. The paper feed roller 23 feeds the paper on the paper feed tray 15 toward a transport path 24. The paper fed to the transport path 24 reaches the pair of transport rollers 25. The pair of transport rollers 25 transports the paper that has reached them onto the platen 26.

The recording head 21 selectively ejects ink onto the sheet passing over the platen 26. As a result, an image is recorded on the sheet. The sheet that has passed over the platen 26 reaches the pair of discharge rollers 27. The pair of discharge rollers 27 discharges the sheet that has reached them onto the sheet tray 16 located at the downstream end of the transport path 24.

### [Cartridge Case 110]

As shown in FIG. 2, the cartridge case 110 is a box-shaped structure open at the rear. The cartridge case 110 has an internal space where the ink cartridge 30 is installed. The cartridge case 110 includes a guide surface 161 and a locking portion 139. The guide surface 161 protrudes upward from the upper surface of the bottom wall of the cartridge case 110. The guide surface 161 extends frontward from the rear end of the cartridge case 110. The guide surface 161 is an upward-facing curved surface.

The guide surface 161 guides the ink cartridge 30 in the front-rear direction during attachment and detachment with respect to the cartridge case 110 of the ink cartridge 30. When the ink cartridge 30 is mounted in the cartridge case 110, the guide surface 161 supports the lower end of the ink cartridge 30.

The locking portion 139 is located at the rear end of the upper wall of the cartridge case 110. The locking portion 139 is a rod-shaped member extending in the left-right direction. The locking portion 139 contacts the lock surface 78F of the ink cartridge 30 mounted in the cartridge case 110.

### [Subtank 120]

The sub tank 120 is located frontward of the cartridge case 110. The sub tank 120 has a vertically elongated rectangular parallelepiped shape. The sub tank 120 is capable of storing ink. The internal space 120A of the sub tank 120 is open to the atmosphere and communicates with the outside at the upper part of the sub tank 120. The ink in the internal space 120A of the sub tank 120 is supplied to the recording head 21 through the ink tube 20. The sub tank 120 includes a supply pipe 102 and a rod 121.

The supply pipe 102 extends rearward from the lower end of the rear wall of the sub tank 120. The supply pipe 102 passes through the front wall of the cartridge case 110 to the rear. The supply pipe 102 is connected to the lower valve mechanism 12 of the ink cartridge 30, which will be described later. Ink supplied from the ink cartridge 30 through the supply pipe 102 is stored in the internal space 120A of the sub tank 120.

The rod 121 extends rearward from the upper end of the rear wall of the sub tank 120. The rod 121 penetrates rearward through the front wall of the cartridge case 110. The rod 121 is connected to the upper valve mechanism 504 of the ink cartridge 30, which will be described later. As a result, air can flow into the ink reservoir chamber 46 of the ink cartridge 30 through the upper valve mechanism 504 from the outside.

### [Ink Cartridge 30]

The following explanation assumes the mounted posture in which the ink cartridge 30 is installed in the cartridge case 110. The ink cartridge 30 has a flat cuboid shape, with a length of the ink cartridge 30 in the left-right direction being smaller than a length of the ink cartridge 30 in the vertical and a length of the ink cartridge 30 in the front-rear directions. The ink cartridge 30 is an example of a liquid cartridge.

As shown in FIGS. 2, 3, and 4, the ink cartridge 30 includes a container body 31, a lower valve mechanism 12, the upper valve mechanism 504, and a front cover 32. The container body 31 is a container that has an ink reservoir chamber 46 where ink is stored. The container body 31 includes a front wall 40, a rear wall 41, a left wall 42, a right wall 43, a top wall 44, a bottom wall 45, an ink supply portion 33, an operation section 51, and a lock section 78.

The front wall 40 is located at the front end of the ink cartridge 30. The rear surface 40A of the front wall 40 defines the front end of the ink reservoir chamber 46. The front wall 40 includes an upper front wall 40U and a lower front wall 40L. The upper front wall 40U is positioned frontward and above the lower front wall 40L. The upper front wall 40U has a cylindrical atmosphere communication section 502 that defines an atmosphere communication port 501. The atmosphere communication port 501 opens toward the front. The atmosphere communication section 502 extends rearward from the atmosphere communication port 501.

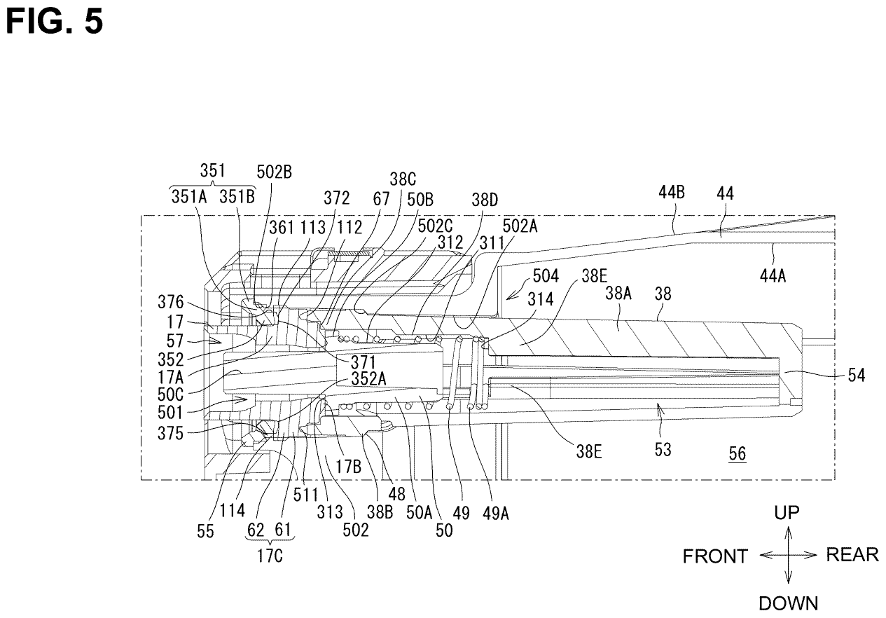

As shown in FIG. 5, the inner peripheral surface 502A of the air communication part 502 has an upper front step surface 502B and an upper rear step surface 502C. The upper front step surface 502B is located behind the air communication port 501. The upper front step surface 502B has an annular shape that is inclined in the front-rear direction so that the inner diameter slightly decreases toward the rear. In other words, the upper front step surface 502B partitions the internal space of the air communication part 502 so that the internal space gradually narrows toward the rear.

The upper rear stepped surface 502C is located behind the upper front stepped surface 502B. The upper rear stepped surface 502C has an annular shape that is inclined in the front-rear direction so as to incline inward in the radial direction of the atmospheric communication portion 502 toward the rear. In other words, the upper rear stepped surface 502C has an annular shape that is inclined in the front-rear direction so that the inner diameter gradually decreases toward the rear. To put it another way, the upper rear stepped surface 502C partitions the internal space of the atmospheric communication portion 502 so that the internal space gradually narrows toward the rear. The atmospheric communication portion 502 is an example of the first cylindrical portion.

As shown in FIG. 2, the lower front wall 40L extends rearward from the lower end of the upper front wall 40U and bends downward, forming an L-shaped structure. The rear surface of the lower front wall 40L defines the front end of the ink reservoir chamber 46. The upper surface of the lower front wall 40L defines the lower end at the front end portion of the ink reservoir chamber 46.

The rear wall 41 is located at the rear end of the ink cartridge 30. The rear wall 41 faces the front wall 40 in the front-rear direction. The front surface 41A of the rear wall 41 defines the rear end of the ink storage chamber 46. The rear surface 41B of the rear wall 41 faces rearward.

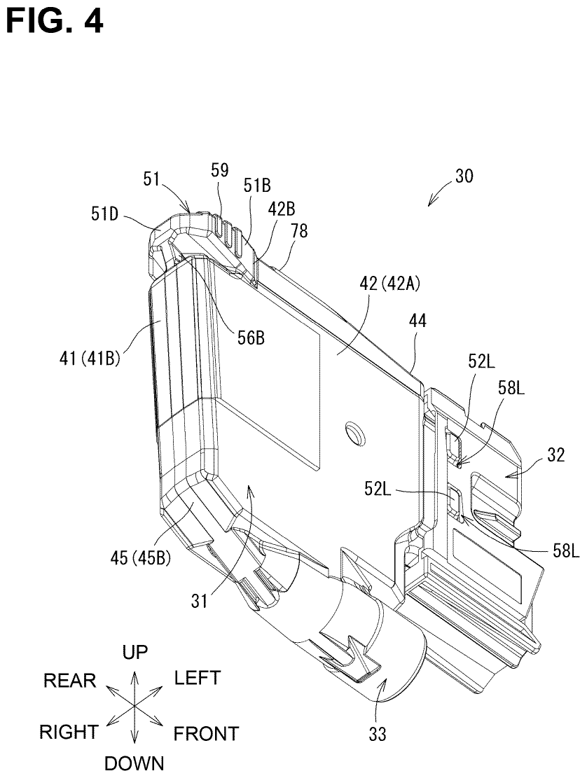

As shown in FIG. 4, the left wall 42 is positioned at the left end of the ink cartridge 30. The left wall 42 is continuous with the left end of the front wall 40 and the left end of the rear wall 41. The right surface of the left wall 42 defines the left end of the ink reservoir chamber 46. The left surface 42A of the left wall 42 faces to the left. The left surface 42A of the left wall 42 has a left projecting surface 42B. The left projecting surface 42B is located at the upper and rear end of the left surface 42A. The left projecting surface 42B is inclined in the front-rear direction so that it extends leftward as it goes toward the rear.

Two left engagement protrusions 52L are located at the front end of the left surface 42A of the left wall 42. The two left engagement protrusions 52L are positioned with a vertical gap between them. The two left engagement protrusions 52L protrude leftward from the left surface 42A of the left wall 42. Viewed from the left, the two left engagement protrusions 52L have a rectangular shape elongated in the vertical direction. The two left engagement protrusions 52L are inserted into the two left through holes 58L of the front cover 32, which will be described later.

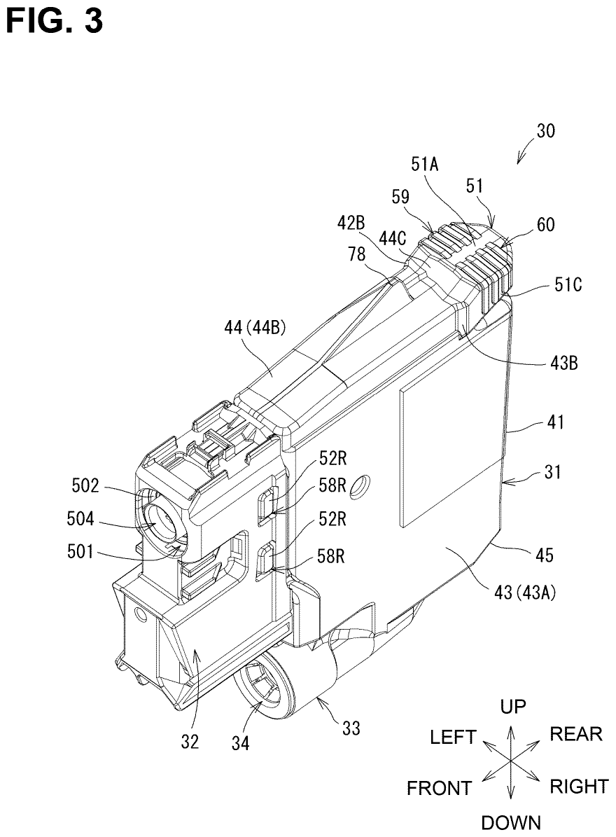

As shown in FIG. 3, the right wall 43 is located at the right end of the ink cartridge 30. The right wall 43 faces the left wall 42 in the left-right direction. The right wall 43 is continuous with the right end of the front wall 40 and the right end of the rear wall 41. The left surface of the right wall 43 defines the right end of the ink reservoir chamber 46. The right surface 43A of the right wall 43 faces right. The right surface 43A of the right wall 43 has a right protruding surface 43B. The right protruding surface 43B of the right wall 43 is located at the upper and rear end of the right surface 43A of the right wall 43. The right protruding surface 43B of the right wall 43 is inclined in the front-rear direction so as to face rightward toward the rear.

Two right engaging protrusions 52R are positioned at the front end portion of the right surface 43A of the right wall 43. The two right engaging protrusions 52R are spaced apart in the vertical direction. The two right engaging protrusions 52R protrude rightward from the right surface 43A of the right wall 43. The two right engaging protrusions 52R are vertically elongated rectangular shapes when viewed from the right side. The two right engaging protrusions 52R are inserted into two right through holes 58R of the front cover 32, which will be described later.

As shown in FIGS. 2 and 3, the upper wall 44 is located at the upper end of the ink cartridge 30. The upper wall 44 is continuous with the upper ends of the front wall 40, the left wall 42, and the right wall 43. The lower surface 44A of the upper wall 44 defines the upper end of the ink reservoir chamber 46. The upper surface 44B of the upper wall 44 has an upward inclined surface 44C. The upward inclined surface 44C is located at the rear end portion of the upper surface 44B. The upward inclined surface 44C is inclined in the front-rear direction so as to rise upward toward the rear.

The bottom wall 45 is located at the lower end and rear end of the ink cartridge 30. The bottom wall 45 faces the top wall 44 in the vertical direction. The bottom wall 45 is continuous with the lower ends of the rear wall 41, the left wall 42, and the right wall 43. The upper surface 45A and the lower surface 45B of the bottom wall 45 are inclined downward in the front-rear direction as they extend frontward. The upper surface 45A of the bottom wall 45 defines the lower and rear end of the ink reservoir 46. The container body 31 is an example of a housing.

The ink supply section 33 is located at the lower end of the container body 31. The ink supply section 33 has a cylindrical shape that defines an ink outlet 34 opening frontward. The ink supply section 33 is continuous with the lower end of the front lower wall 40L and the front end of the rear wall 41. The lower end portion of the inner peripheral surface 33A of the ink supply section 33 defines the lower end portion of the ink reservoir chamber 46. The ink supply section 33 is an example of the second cylindrical portion.

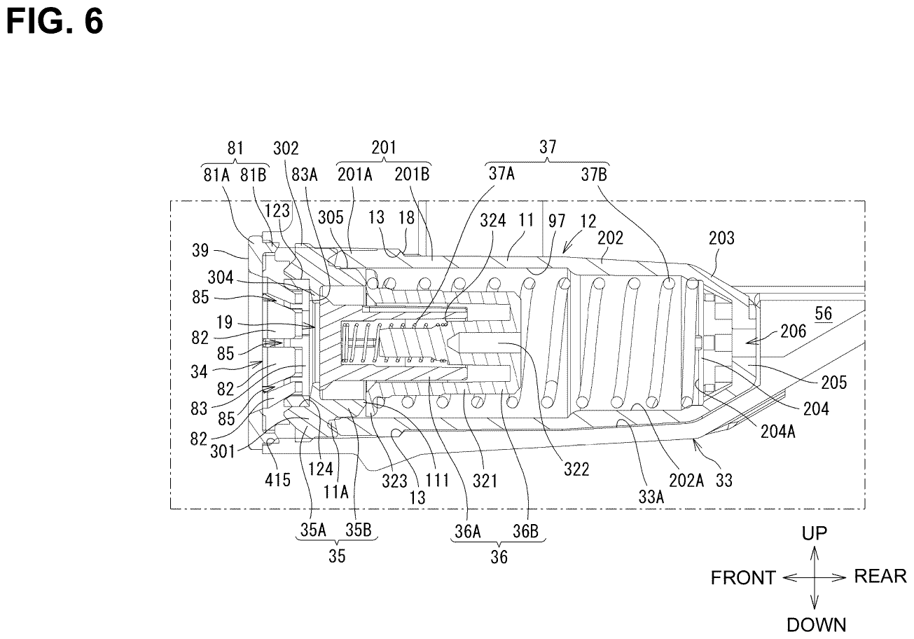

As shown in FIG. 6, the inner peripheral surface 33A of the ink supply unit 33 has a lower front step surface 415 and a lower rear step surface 13. The lower front step surface 415 is located just behind the ink flow outlet 34. The lower front step surface 415 has an annular shape inclined in the front-rear direction such that the inner diameter gradually decreases toward the rear. In other words, the lower front step surface 415 partitions the internal space of the ink supply unit 33 so that the internal space gradually narrows toward the rear.

The lower rear stepped surface 13 is located behind the lower front stepped surface 415. The lower rear stepped surface 13 has an annular shape that is inclined in the front-rear direction so that the inner diameter gradually decreases toward the rear. In other words, the lower rear stepped surface 13 partitions the internal space of the ink supply section 33 so that the internal space gradually narrows toward the rear.

The operation unit 51 is located at the upper end and the rear end of the ink cartridge 30. The operation unit 51 is hollow. The internal space of the operation unit 51 communicates with the ink reservoir chamber 46. In other words, the inner surface 52 of the operation unit 51 defines the ink reservoir chamber 46. The operation unit 51 has an upper surface 51A, a left surface 51B, a right surface 51C, and a rear surface 51D.

The upper surface 51A faces upward. The upper surface 51A is positioned above the upper surface 44B of the upper wall 44. The upper surface 51A is continuous with the upwardly inclined surface 44C. The left surface 51B faces left. The left surface 51B is continuous with the left edge of the upper surface 51A. The right surface 51C faces right. The right surface 51C is continuous with the right edge of the upper surface 51A. The rear surface 51D faces rearward. The rear surface 51D is continuous with the rear edge of the upper surface 51A, the rear edge of the left surface 51B, and the rear edge of the right surface 51C.

As shown in FIGS. 3 and 4, multiple left protrusions 59 are located to the left of the center in the left-right direction of the operation unit 51. The multiple left protrusions 59 are positioned at equal intervals in the front-rear direction. The multiple left protrusions 59 have an L-shaped form continuous from the upper surface 51A to the left surface 51B.

Multiple right protrusions 60 are located to the right of the center in the left-right direction of the operation unit 51. The multiple right protrusions 60 are positioned at equal intervals in the front-rear direction. The multiple right protrusions 60 have an L-shaped form that extends continuously from the top surface 51A to the right surface 51C.

The lock portion 78 protrudes upward from the upper surface 44B of the upper wall 44. The lock portion 78 is located in front of the operation portion 51. The lock portion 78 is positioned to the right of the center in the left-right direction on the upper surface 44B of the upper wall 44. The lock portion 78 has a lock face 78F. The lock face 78F is a plane facing backward. When the ink cartridge 30 is mounted in the cartridge case 110, the lock face 78F is configured to contact the lock portion 139 of the cartridge case 110.

The container body 31 is formed by blow molding. Specifically, a cylindrical parison extruded from the blow molding machine is first clamped by a mold. Next, a blow pin is screwed into the parison clamped by the mold. Finally, air is injected from the blow pin into the parison. This process forms the container body 31.

As shown in FIG. 6, the lower valve mechanism 12 is at least partially housed within the internal space of the ink supply section 33. The lower valve mechanism 12 includes a lower support member 11, a lower seal member 35, a lower valve 36, a lower coil spring 37, and a lower cap 39.

The lower support member 11 is housed within the internal space of the ink supply unit 33. The lower support member 11 has a cylindrical shape extending in the front-rear direction. The lower support member 11 is an injection-molded product. The lower support member 11 includes a cylindrical portion 201, a reduced-diameter portion 202, a conical portion 203, and a base 204.

The cylindrical portion 201 includes a large-diameter part 201A and a small-diameter part 201B. The large-diameter part 201A forms the front end portion of the lower support member 11. The front end 11A of the large-diameter part 201A is positioned behind the ink outlet 34. The outer diameter of the large-diameter part 201A is larger than that of the small-diameter part 201B.

The small-diameter portion 201B extends rearward from the rear end of the large-diameter portion 201A. The inner diameter of the small-diameter portion 201B is the same as the inner diameter of the large-diameter portion 201A. In other words, the inner peripheral surface of the cylindrical portion 201 is flush from the front end to the rear end. The outer diameter of the small-diameter portion 201B is slightly smaller than that of the large-diameter portion 201A. As a result, the rear end of the large-diameter portion 201A forms a step 18 with the outer peripheral surface of the small-diameter portion 201B.

Step 18 is in annular contact with the lower rear step surface 13 of the ink supply unit 33. As a result, the lower support member 11 is positioned in the front-rear direction.

The reduced diameter section 202 extends rearward from the rear end of the small diameter section 201B. The outer peripheral surface of the reduced diameter section 202 is slightly inclined inward in the front-rear direction so that the outer diameter gradually decreases toward the rear. The inner diameter of the reduced diameter section 202 is smaller than the inner diameters of the large diameter section 201A and the small diameter section 201B. The inner diameter of the reduced diameter section 202 remains constant from the front end to the rear end.

The conical section 203 extends rearward from the rear end of the reduced diameter section 202. The outer peripheral surface of the conical section 203 is inclined inward in the front-rear direction so that the outer diameter decreases toward the rear. The conical section 203 has a circular through-hole 206 that passes through in the front-rear direction. The through-hole 206 is partitioned by an annular partition wall 205 that protrudes inward from the inner peripheral surface of the conical section 203.

The pedestal 204 is located in front of the partition wall 205. The pedestal 204 has a spring support surface 204A facing frontward.

The lower seal member 35 is an annular elastic member. The material of the lower seal member 35 is, for example, rubber. The lower seal member 35 has a circular lower through-hole 19 that penetrates in the front-rear direction. The lower seal member 35 is positioned inside the internal space of the ink supply section 33. The lower seal member 35 is in close with the inner peripheral surface 33A of the ink supply section 33 slightly behind the ink outlet 34. The lower seal member 35 has a front part 35A and a rear part 35B.

The front portion 35A includes a cylindrical body 301, an outer projection 302, and an inner projection 304. The cylindrical body 301 is a cylinder-shaped body extending in the front-rear direction. The rear end of the cylindrical body 301 is in contact with the front end 11A of the lower support member 11. The outer projection 302 is an annular protrusion that protrudes outward from the outer peripheral surface of the cylindrical body 301. The outer projection 302 is located at the front end portion of the outer peripheral surface of the cylindrical body 301. The outer projection 302 is in close with the entire inner peripheral surface of the ink supply section 33.

The inner protrusion 304 is an annular protrusion that projects inward from the inner peripheral surface of the cylindrical body 301. The inner protrusion 304 is positioned slightly behind the outer protrusion 302 in the front-rear direction. The protruding end of the inner protrusion 304 defines the lower through hole 19. The lower through hole 19 is an example of the second through hole.

The rear portion 35B is a cylindrical tube extending rearward from the rear end of the cylinder 301. The rear portion 35B is positioned inward from the radial center of the cylinder 301. The rear portion 35B is located with a radial gap inward from the inner peripheral surface 33A of the ink supply section 33. The outer peripheral surface 305 of the rear portion 35B is in contact with the inner peripheral surface at the front end portion of the lower support member 11. The lower seal member 35 is an example of a second seal member.

The lower valve 36 is located within the internal space of the lower support member 11. The lower valve 36 is movable in the front-rear direction within the internal space of the lower support member 11. When the lower valve 36 is in contact with the lower seal member 35, the ink outlet 34 is sealed. Specifically, the lower valve 36 includes a first valve 36A and a second valve 36B.

The first valve 36A is in contact with the rear surface of the inner protrusion 304. The first valve 36A has a cylindrical shape extending rearward from the rear surface of the inner protrusion 304. The front end of the first valve 36A is closed. The rear end of the first valve 36A is open toward the rear.

The first valve 36A is movable in the front-rear direction between the first closed position and the first open position. The first closed position is where the front end of the first valve 36A contacts the rear surface of the inner protrusion 304. In the first closed position, the first valve 36A closes the lower through hole 19. The first open position is a position where the front end of the first valve 36A is located behind the first closed position. In the first open position, the first valve 36A opens the lower through hole 19.

The second valve 36B includes a housing section 321, a cylindrical section 322, and a flange section 323. The housing section 321 has a cylindrical shape extending in the front-rear direction. The front end of the housing section 321 is open toward the front. The rear end of the housing section 321 is closed. The inner diameter of the housing section 321 is slightly larger than the outer diameter of the first valve 36A. A part of the first valve 36A is located inside the internal space of the housing section 321.

The cylindrical part 322 is located within the internal space of the housing part 321. The cylindrical part 322 has a cylindrical shape extending frontward from the front surface of the rear wall of the housing part 321. A portion of the first valve 36A is positioned between the outer peripheral surface of the cylindrical part 322 and the inner peripheral surface of the housing part 321. The cylindrical part 322 has a ring-shaped spring support surface 324 facing frontward. The spring support surface 324 is located at the center in the front-back direction on the outer peripheral surface of the cylindrical part 322.

The flange portion 323 has an annular shape that protrudes outward from the outer peripheral surface of the accommodating portion 321. The flange portion 323 is located at the front end of the accommodating portion 321. The protruding end of the flange portion 323 is positioned close to the inner peripheral surface 97 of the cylindrical portion 201 of the lower support member 11. As a result, the second valve 36B is positioned in a direction perpendicular to the front-rear direction. Consequently, the posture of the second valve 36B is maintained.

The second valve 36B is movable in the front-rear direction between the second closed position and the second open position. The second closed position is where the front surface of the flange portion 323 contacts the rear end 111 of the rear part 35B. In the second closed position, the second valve 36B closes the lower through hole 19. The second open position is located rearward of the second closed position, where the flange portion 323 is positioned behind. In the second open position, the second valve 36B opens the lower through hole 19. The lower valve 36 is an example of the second valve.

The lower coil spring 37 biases the lower valve 36 toward the lower seal member 35. Specifically, the lower coil spring 37 includes a first coil spring 37A and a second valve 36B.

The first coil spring 37A can be compressed in the front-rear direction. The rear end of the first coil spring 37A is supported by the spring support surface 324 of the cylindrical portion 322. The front end of the first coil spring 37A is supported on the rear surface of the front wall of the first valve 36A. As a result, the first coil spring 37A presses the front end of the first valve 36A against the rear surface of the inner projection 304 of the lower seal member 35.

The second coil spring 37B is compressible in the front-rear direction. The spring constant of the second coil spring 37B is greater than that of the first coil spring 37A. The rear end of the second coil spring 37B is supported by the spring support surface 204A of the base 204. The front end of the second coil spring 37B is supported on the rear surface of the flange portion 323. As a result, the second coil spring 37B presses the front surface of the flange portion 323 against the rear end 111 of the rear part 35B of the lower seal member 35. The outer surface of the second coil spring 37B is positioned close to the inner circumferential surface 202A of the diameter-reduced portion 202 of the lower support member 11. This guides the second coil spring 37B in the front-rear direction. The lower coil spring 37 is an example of the second urging member. The lower valve mechanism 12 is an example of the second valve mechanism.

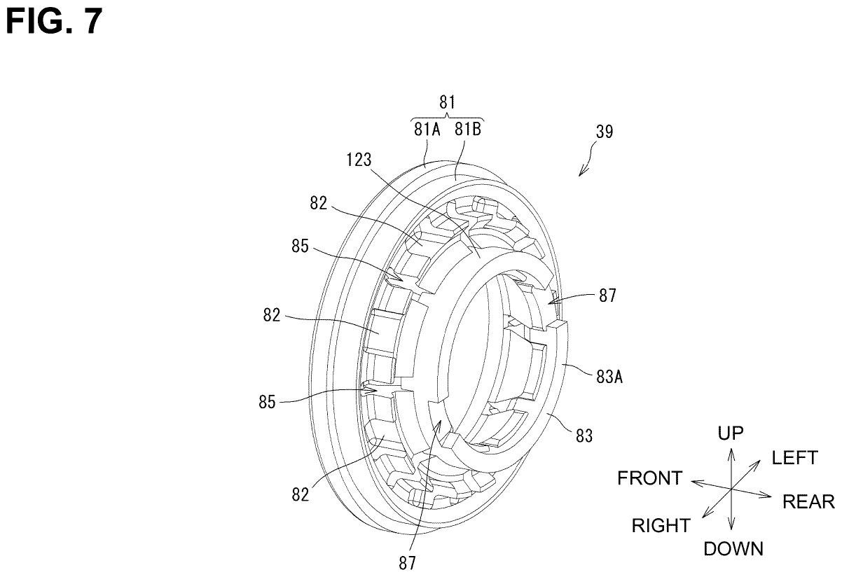

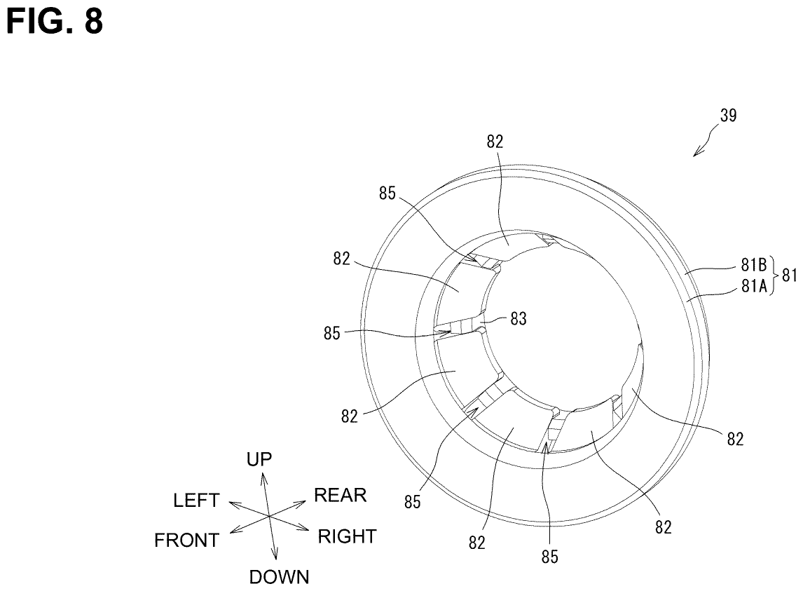

The lower cap 39 is welded to the inner peripheral surface 33A of the ink supply part 33 around the ink flow outlet 34. As shown in FIGS. 7 and 8, the lower cap 39 has a cylindrical shape extending in the front-rear direction. The front end of the lower cap 39 is open toward the front. The rear end of the lower cap 39 is open toward the rear. As shown in FIG. 6, the lower cap 39 contacts the lower seal member 35 from the front. Specifically, the lower cap 39 includes a lower mounting part 81, multiple connecting pieces 82, and a lower contact part 83.

The lower mounting portion 81 is located at the ink outlet 34. The lower mounting portion 81 has a lower contact wall 81A and a lower welding wall 81B. The lower contact wall 81A is positioned at the front end of the ink supply portion 33. The lower contact wall 81A is ring-shaped. The rear surface of the lower contact wall 81A contacts the entire circumference of the front end of the ink supply portion 33.

The lower welding wall 81B has an annular shape extending rearward from the back surface of the lower contact wall 81A. The outer peripheral surface of the lower welding wall 81B is positioned radially inward from the outer peripheral surface of the lower contact wall 81A toward the lower cap 39. The lower end of the lower welding wall 81B contacts the lower front step surface 415 of the ink supply section 33. The rear end of the lower welding wall 81B is inclined in the front-rear direction so as to incline frontward as it moves radially inward toward the lower cap 39. The lower end of the lower welding wall 81B is fixed to the lower front step surface 415 by welding. The lower mounting section 81 is an example of a second cap body.

Multiple connecting pieces 82 extend rearward from the inner edge of the rear surface of the lower abutment wall 81A. The multiple connecting pieces 82 are positioned at equal intervals in the circumferential direction of the lower abutment wall 81A. The multiple connecting pieces 82 have a flat plate shape extending in both the circumferential and front-rear directions of the lower abutment wall 81A. The inner surfaces and rear surfaces of the multiple connecting pieces 82 are inclined in the front-rear direction so as to face inward in the radial direction of the lower abutment wall 81A as they extend rearward. A lower gap 85 exists between connecting pieces 82 adjacent to each other in the circumferential direction of the lower abutment wall 81A. The lower gaps 85 are positioned at equal intervals in the circumferential direction of the lower abutment wall 81A.

The lower contact portion 83 is positioned behind the lower mounting portion 81 with a gap in-between. The lower contact portion 83 has an annular shape extending rearward from the rear end of the inner surface of the plurality of connecting pieces 82. The lower contact portion 83 connects the plurality of connecting pieces 82 in the circumferential direction. In other words, the plurality of connecting pieces 82 connect the lower mounting portion 81 and the lower contact portion 83 in the front-rear direction. The outer peripheral surface 123 of the lower contact portion 83 contacts the inner peripheral surface 124 of the front part 35A of the lower seal member 35. The lower contact portion 83 has two notches 87 cut frontward from the rear end surface 83A of the lower contact portion 83. The two notches 87 are positioned 180 degrees apart around the center of the lower contact portion 83. The two notches 87 have a long rectangular shape in the circumferential direction of the lower contact portion 83. The rear end surface 83A of the lower contact portion 83 contacts the front surface of the inner projection 304 of the lower seal member 35. The lower contact portion 83 is an example of a third contact portion. The lower cap 39 is an example of a second cap.

As shown in FIG. 5, the upper valve mechanism 504 is at least partially housed within the internal space of the atmospheric communication section 502. The upper valve mechanism 504 includes an upper support member 38, an upper seal member 17, an upper valve 50, an upper coil spring 49, and an upper cap 55. The upper valve mechanism 504 is an example of a first valve mechanism.

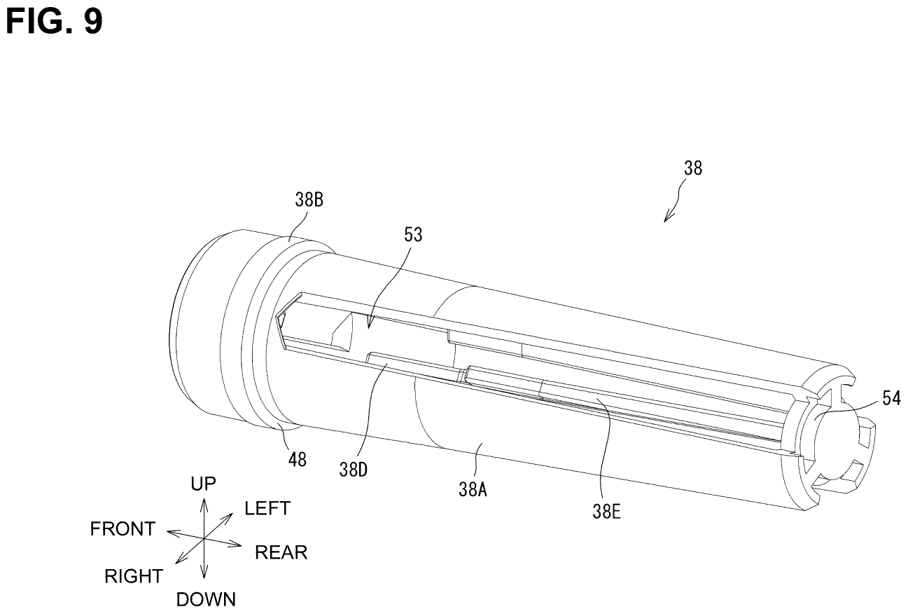

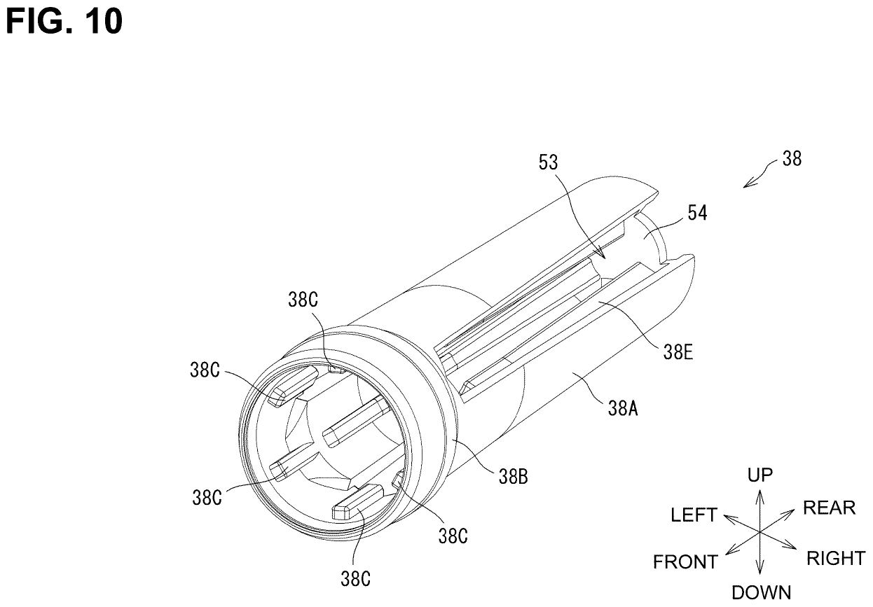

The upper support member 38 is located within the internal space of the atmospheric communication section 502. As shown in FIGS. 9 and 10, the upper support member 38 has a cylindrical shape extending in the front-rear direction. The upper support member 38 includes a cylindrical body 38A, outer ribs 38B, multiple inner ribs 38C, multiple front spring support sections 38D, and multiple rear spring support sections 38E.

The cylindrical body 38A has a cylindrical shape extending in the front-rear direction. The rear end of the cylindrical body 38A is closed. The front end of the cylindrical body 38A is open toward the front. As shown in FIGS. 2 and 5, the cylindrical body 38A extends rearward from a position behind the atmospheric communication port 501 to a position slightly behind the center in the front-rear direction of the ink storage chamber 46. The outer peripheral surface of the cylindrical body 38A is slightly inclined in the front-rear direction so as to taper inward in the radial direction toward the rear. In other words, the outer peripheral surface of the upper support member 38 is a tapered surface that slightly decreases in diameter toward the rear.

As shown in FIGS. 5, 9, and 10, the cylindrical body 38A has three slits 53 that connect the internal space of the cylindrical body 38A with the outside. The three slits 53 are positioned at equal intervals in the circumferential direction of the cylindrical body 38A. In other words, the three slits 53 are located at positions 120 degrees apart around the center of the cylindrical body 38A. The three slits 53 extend in the front-rear direction. The three slits 53 extend from the front end to the rear end of the cylindrical body 38A. The three slits 53 open rearward at the rear end of the cylindrical body 38A.

The outer rib 38B has an annular shape protruding outward from the outer peripheral surface of the cylindrical body 38A. The outer rib 38B is positioned frontward of the three slits 53. The rear surface 48 of the outer rib 38B is inclined with respect to the radial direction of the cylindrical body 38A so that it slopes rearward as it moves radially inward toward the cylindrical body 38A. The rear surface 48 of the outer rib 38B is in contact with from behind against the upper rear stepped surface 502C of the atmospheric communication part 502. As a result, the upper support member 38 is positioned in the front-rear direction. The rear surface 48 of the outer rib 38B and the upper rear stepped surface 502C of the atmospheric communication part 502 contact each other obliquely in the front-rear direction. This configuration makes it difficult for the ink in the ink reservoir chamber 46 to leak frontward through the gap between the rear surface 48 and the upper rear stepped surface 502C. The upper rear stepped surface 502C is an example of a stepped surface. The rear surface 48 is an example of the rear surface of the outer rib.

A plurality of inner ribs 38C protrude inwardly from the inner peripheral surface of the cylindrical body 38A. The plurality of inner ribs 38C are located at the front end portion of the inner peripheral surface of the cylindrical body 38A. The plurality of inner ribs 38C extend in the front-rear direction. The plurality of inner ribs 38C are positioned at equal intervals in the circumferential direction of the cylindrical body 38A. In this embodiment, six inner ribs are positioned at equal intervals in the circumferential direction of the cylindrical body 38A. The plurality of inner ribs 38C are an example of a plurality of second ribs. The circumferential direction is an example of the peripheral direction.

Multiple front spring support portions 38D are positioned rearward at intervals from multiple inner ribs 38C. The multiple front spring support portions 38D protrude inward from the inner peripheral surface of the cylindrical body 38A, more than the multiple inner ribs 38C. The multiple front spring support portions 38D extend in the front-rear direction. The multiple front spring support portions 38D are positioned at equal intervals in the circumferential direction of the cylindrical body 38A. In this embodiment, three front spring support portions are positioned at equal intervals in the circumferential direction of the cylindrical body 38A. The multiple front spring support portions 38D are an example of multiple third ribs.

Multiple rear spring support sections 38E extend rearward from the rear ends of multiple inner ribs 38C to the front surface of the rear wall 54 of the cylindrical body 38A. The multiple rear spring support sections 38E protrude inward more than the multiple inner ribs 38C. The front surfaces 314 of the multiple rear spring support sections 38E face frontward. The multiple rear spring support sections 38E are positioned at equal intervals in the circumferential direction of the cylindrical body 38A. In this embodiment, three rear spring support sections 38E are positioned at equal intervals in the circumferential direction of the cylindrical body 38A.

As shown in FIG. 5, the upper seal member 17 is located within the internal space of the atmospheric communication part 502. The upper seal member 17 has a cylindrical shape extending in the front-rear direction. The front end of the upper seal member 17 is positioned ahead of the atmospheric communication port 501. The lower seal member 35 is an annular elastic member. The material of the lower seal member 35 is, for example, rubber.

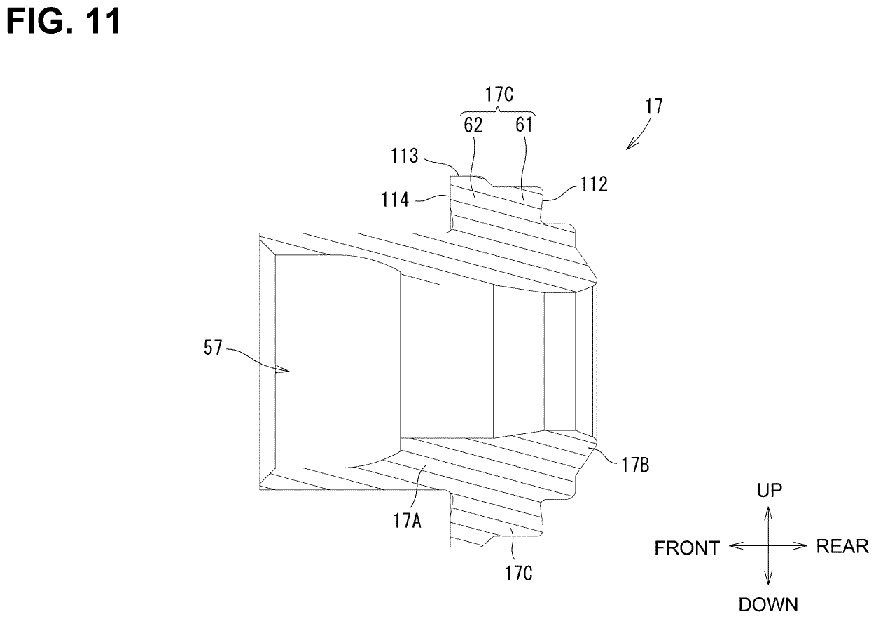

As shown in FIGS. 5 and 11, the upper seal member 17 has a circular upper through-hole 57 that extends in the front-rear direction. The upper seal member 17 includes a seal body 17A, a rear lip 17B, and an outer contact portion 17C. The upper seal member 17 is an example of a first seal member.

The seal body 17A defines the upper through-hole 57. The thickness of the seal body 17A tapers so that the inner diameter of the upper through-hole 57 increases toward the front. The upper through-hole 57 is an example of a first through-hole. The outer peripheral portion of the rear surface 67 of the seal body 17A contacts the front surfaces of multiple inner ribs 38C. As a result, the multiple inner ribs 38C uniformly contact the rear surface 67 of the seal body 17A in the circumferential direction of the upper support member 38. The rear lip 17B has an annular shape extending rearward from the entire inner peripheral portion of the rear surface 67 of the seal body 17A. The rear surface 67 is an example of the rear surface of the first seal member.

The outer contact portion 17C has an annular shape extending outward from the outer peripheral surface of the seal body 17A. The outer contact portion 17C is located rearward of the center in the front-rear direction of the seal body 17A. The outer contact portion 17C includes a rear portion 61 and a front portion 62. The rear portion 61 constitutes the rear side of the center in the front-rear direction of the outer contact portion 17C. The rear surface 112 of the rear portion 61 contacts the front end 511 of the upper support member 38. As a result, the upper seal member 17 is positioned in the front-rear direction. The front end 511 is an example of the second contact portion.

The front portion 62 constitutes the area frontward of the center in the front-rear direction of the outer contact portion 17C. The front portion 62 protrudes radially outward from the sealing member 17 more than the rear portion 61. The outer peripheral surface 113 of the front portion 62 is in close with the inner peripheral surface 502A of the atmospheric communication portion 502. The front surface 114 of the front portion 62 is a plane facing frontward. The front surface 114 of the front portion 62 is a plane orthogonal to the front-rear direction. The outer contact portion 17C is an example of the first contact portion. The front surface 114 is an example of a front surface.

The upper valve 50 is located in the internal space of the upper support member 38. The upper valve 50 includes a cylindrical body 50A, a contact piece 50B, and a columnar body 50C.

The cylindrical body 50A is located behind the upper seal member 17. The cylindrical body 50A has a cylindrical shape extending in the front-rear direction. The front end 313 of the cylindrical body 50A is closed. The rear end of the cylindrical body 50A is open to the rear. The outer peripheral surface 312 of the cylindrical body 50A is positioned radially inward from the protruding end face 311 of the multiple front spring support parts 38D with a gap from the upper support member 38. The front surface of the cylindrical body 50A contacts the rear lip 17B of the upper seal member 17.

The contact piece 50B has an annular shape that protrudes radially outward from the outer peripheral surface 312 of the cylindrical body 50A and the upper support member 38. The contact piece 50B is located at the front end of the cylindrical body 50A. The protruding end of the contact piece 50B contacts the protruding ends of multiple inner ribs 38C. The columnar body 50C has a columnar shape extending frontward from the front end 313 of the cylindrical body 50A. The columnar body 50C extends the upper through-hole 57 in the front-back direction. There is a gap between the columnar body 50C and the inner surface of the upper through-hole 57 through which air can flow.

The upper valve 50 can move back and forth between the third closed position and the third open position. The third closed position is where the front end 313 of the cylindrical body 50A contacts the rear lip 17B. In the third closed position, the upper valve 50 closes the upper through-hole 57. The third open position is where the front end 313 of the cylindrical body 50A is positioned rearward, away from the rear lip 17B. In the third open position, the upper valve 50 opens the upper through-hole 57.

The upper coil spring 49 is located within the internal space of the upper support member 38. The upper coil spring 49 is positioned between the contact piece 50B and multiple rear spring support parts 38E. The upper coil spring 49 is compressible in the front-rear direction. The front end of the upper coil spring 49 is supported by the rear surface of the contact piece 50B. The rear end of the upper coil spring 49 is supported by the front surfaces 314 of the multiple rear spring support parts 38E. The outer peripheral surface 49A of the upper coil spring 49 contacts the protruding end surfaces 311 of the multiple front spring support parts 38D. The upper coil spring 49 is an example of the first biasing member.

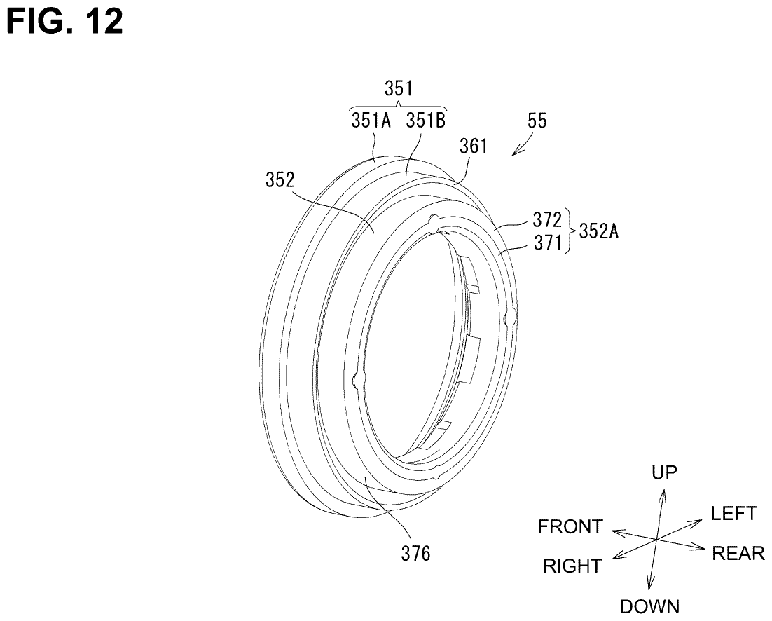

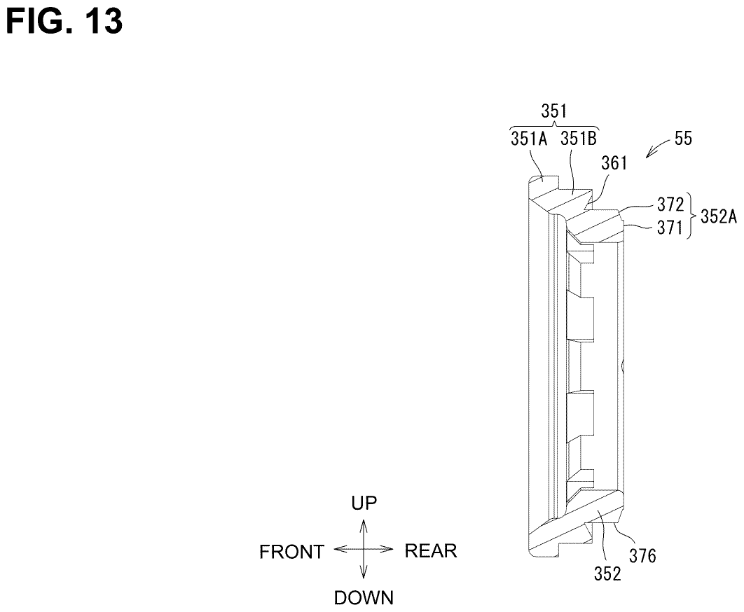

As shown in FIG. 5, the upper cap 55 is located at the atmospheric communication port 501. The upper cap 55 is mounted on the front end portion of the atmospheric communication section 502. The upper cap 55 is in contact with the upper seal member 17 from the front. As shown in FIGS. 12 and 13, the upper cap 55 has an annular shape. Specifically, the upper cap 55 includes an upper mounting portion 351 and an upper contact portion 352. The upper cap 55 is an example of a first cap.

As shown in FIG. 5, the upper mounting portion 351 is located at the front end of the atmospheric communication part 502. The upper mounting portion 351 has an upper contact wall 351A and an upper welding wall 351B. The upper contact wall 351A is annular in shape. The upper contact wall 351A contacts the entire circumference at the front end of the atmospheric communication part 502.

The upper welding wall 351B has an annular shape extending rearward from the back surface of the upper contact wall 351A. The outer peripheral surface of the upper welding wall 351B is located radially inward of the outer peripheral surface of the upper contact wall 351A with respect to the upper cap 55. The rear surface 361 of the upper welding wall 351B is inclined with respect to the radial direction of the upper cap 55 so that it faces frontward as it moves radially inward toward the upper cap 55. The rear surface 361 of the upper welding wall 351B is in contact with the upper front step surface 502B of the atmospheric communication part 502. The upper welding wall 351B is fixed to the upper front step surface 502B by welding. The upper mounting part 351 is an example of the first cap body.

The upper contact portion 352 has an annular shape extending downward from the entire inner circumferential surface of the upper welding wall 351B. The outer circumferential surface 376 of the upper contact portion 352 is positioned with a gap inward in the radial direction of the upper cap 55 from the inner circumferential surface 502A of the atmospheric communication portion 502. The rear surface 352A of the upper contact portion 352 is in contact with the front surface 114 of the front part 62 of the upper seal member 17. The upper contact portion 352 is an example of a first rib.

The rear surface 352A has a first surface 371 and a first inclined surface 372. The first surface 371 is located radially inward of the upper cap 55 on the rear surface 352A of the upper contact portion 352. The first surface 371 is a plane perpendicular to the front-rear direction. The first surface 371 faces rearward. The first surface 371 is slightly recessed backward from the front surface 114 of the front portion 62.

The first inclined surface 372 is located radially outward of the upper cap 55 on the first surface 371. The first inclined surface 372 is inclined frontward relative to the radial direction of the upper cap 55 as it extends radially outward. The first inclined surface 372 slightly overlaps rearward from the front surface 114 of the front portion 62.

An upper gap 375 exists between the outer peripheral surface 376 of the upper abutting portion 352 and the inner peripheral surface 502A of the atmospheric communication portion 502. The upper gap 375 is defined by the outer peripheral surface 376 of the upper abutting portion 352, the inner peripheral surface 502A of the atmospheric communication portion 502, the rear surface 361 of the upper welding wall 351B, and the front surface 114 of the front portion 62. The upper gap 375 is an example of a gap.

As shown in FIGS. 2, 3, and 4, the front cover 32 is a box-shaped structure open at the rear. The front cover 32 covers the front end portion of the container body 31. The front cover 32 covers the front end portions of the upper front wall 40U, the upper wall 44, the left wall 42, and the right wall 43 of the container body 31.

The left wall of the front cover 32 has two left through holes 58L spaced apart vertically. These two left through holes 58L are located at the rear end of the left wall of the front cover 32. The two left through holes 58L penetrate the left wall of the front cover 32 in the horizontal direction. Viewed from the left side, the two left through holes 58L are vertically elongated rectangular shapes.

The vertical length of the two left through holes 58L is longer than the vertical length of the two left engaging projections 52L. The front-to-back length of the two left through holes 58L is longer than the front-to-back length of the two left engaging projections 52L. The two left engaging projections 52L are inserted into the two left through holes 58L.

The right wall of the front cover 32 has two right through holes 58R spaced apart vertically. The two right through holes 58R are located at the rear end of the right wall of the front cover 32. The two right through holes 58R penetrate the right wall of the front cover 32 in the left-right direction. The two right through holes 58R are vertically elongated rectangles when viewed from the right side.

The vertical length of the two right through-holes 58R is longer than the vertical length of the two right engaging protrusions 52R. The front-to-back length of the two right through-holes 58R is longer than the front-to-back length of the two right engaging protrusions 52R. The two right engaging protrusions 52R are inserted into the two right through-holes 58R. As a result, the front cover 32 is assembled to the container body 31.

The two left through holes 58L are larger than the outer shape of the two left engaging protrusions 52L. The two right through holes 58R are larger than the outer shape of the two right engaging protrusions 52R. Therefore, when the container body 31 and the front cover 32 are assembled, the front cover 32 can move relative to the container body 31 in the vertical and front-back directions.

[Ink Injection into Ink Cartridge 30]

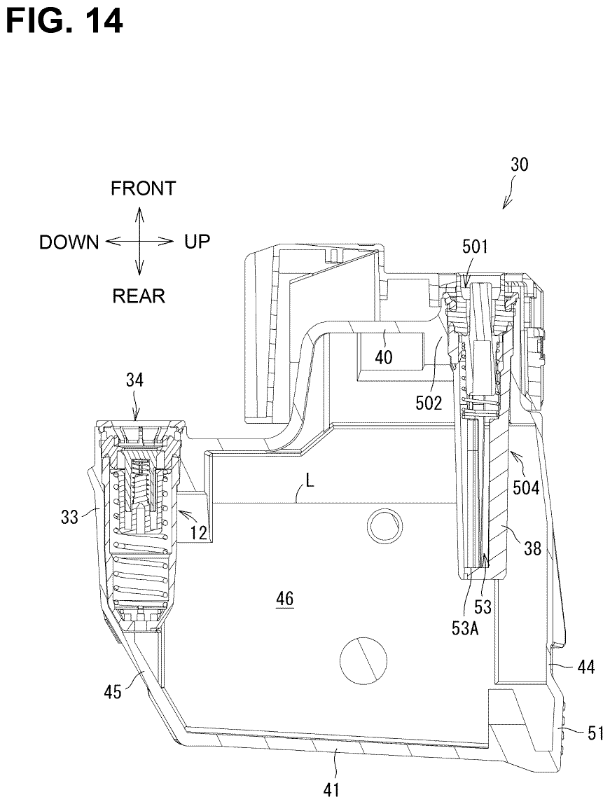

As shown in FIG. 14, ink is injected into the ink storage chamber 46 through the ink outlet 34, which faces upward, opposite to the vertical direction, of the ink cartridge 30. The orientation of the ink cartridge 30 shown in FIG. 14 is the injection posture. In the injection posture, the atmospheric communication port 501 also faces upward. FIG. 14 shows the maximum ink level L when the ink storage chamber 46 is filled with the maximum amount of ink. The lower ends 53A of the three slits 53 are positioned below the maximum liquid level L.

As ink is injected into the ink reservoir 46, bubbles form on the liquid surface. If these ink bubbles remain, they may be supplied to the recording head 21, causing printing defects. In this embodiment, as the liquid surface rises with the injection of ink, the bubbles come into contact with three slits 53. This causes the bubbles to disappear.

[Mounting the Ink Cartridge 30 into the Cartridge Case 110]

The ink cartridge 30 is inserted frontward through the opening 105 into the internal space of the cartridge case 110. The lower end of the inserted ink cartridge 30 is supported by the guide surface 161 of the cartridge case 110.

When the ink cartridge 30 is further inserted frontward, the ink flow outlet 34 receives the supply pipe 102. Once the supply pipe 102 is received by the ink flow outlet 34, the supply pipe 102 pushes the first valve 36A rearward against the biasing force of the first coil spring 37A. As a result, the first valve 36A moves rearward from the first closed position toward the first open position.

As the first valve 36A moves rearward, the urging force of the first coil spring 37A increases. When the first valve 36A moves rearward by a predetermined distance, the urging force of the first coil spring 37A becomes stronger than that of the second coil spring 37B. As a result, the second valve 36B moves rearward from the second closed position toward the second open position against the urging force of the second coil spring 37B. This causes the internal space of the lower support member 11 and the internal space of the supply pipe 102 to communicate with each other. Consequently, ink from the ink storage chamber 46 is supplied to the internal space 120A of the sub tank 120 through the internal space of the supply pipe 102.

Simultaneously, the atmospheric communication port 501 receives the rod 121. When the rod 121 is accepted into the atmospheric communication port 501, it pushes the upper valve 50 backward against the urging force of the upper coil spring 49. As a result, the upper valve 50 moves from the third closed position to the third open position. This opens the atmospheric communication port 501. Through the opened atmospheric communication port 501, the internal space of the upper support member 38, and the three slits 53, air flows from the outside into the ink storage chamber 46.

### [Effects of the Present Embodiment]

In the above embodiment, when the ink cartridge 30 is not installed in the cartridge case 110, the temperature of the ink reservoir chamber 46 may rise. For example, the ink cartridge 30 is not installed in the cartridge case 110 during transportation of the ink cartridge 30. When the temperature of the ink reservoir chamber 46 rises, the air pressure inside the ink reservoir chamber 46 increases, exerting a frontward pushing force on the upper seal member 17. As a result, the upper seal member 17 deforms. During transportation of the ink cartridge 30, since the ink cartridge 30 is not in the installed posture, if the upper seal member 17 deforms, ink tends to leak from the ink outlet 34 to the outside.

In the above embodiment, the first inclined surface 372 of the upper cap 55 is in contact with the front surface 114 of the front portion 62 of the upper seal member 17. Therefore, when a force pushing the upper seal member 17 frontward is applied, a force from the first surface 371 acts on the upper seal member 17 in a direction that presses the front portion 62 against the inner peripheral surface 502A. As a result, the upper seal member 17 firmly adheres to the inner peripheral surface 502A of the atmospheric communication part 502. Thus, ink leakage from the atmospheric communication port 501 to the outside through the space between the inner peripheral surface 502A of the atmospheric communication part 502 and the outer peripheral surface 113 of the front portion 62 is suppressed.

In the above embodiment, when the upper cap 55 is welded to the tip of the atmospheric communication part 502, the melted portion that has flowed out from the upper welding wall 351B flows into the upper gap 375. Therefore, by welding the upper welding wall 351B to the inner peripheral surface 502A of the atmospheric communication part 502, the upper cap 55 is prevented from being significantly deformed.

In the above embodiment, the rear surface 352A of the upper contact portion 352 is in contact with the front surface of the upper sealing member 17. The upper gap 375 is defined by the outer peripheral surface 376 of the upper contact portion 352 and the inner peripheral surface 502A of the atmospheric communication portion 502. The upper gap 375 is also defined by the rear surface 361 of the upper welding wall 351B and the front surface 114 of the front part 62 of the upper sealing member 17. Therefore, any molten part that flows into the upper gap 375 due to the welding of the upper welding wall 351B is confined within the upper gap 375. As a result, the molten portion of the upper welding wall 351B is unlikely to overflow inside the upper cap 55 through the space between the rear surface 352A of the upper contact portion 352 and the front surface 114 of the front part 62.

Moreover, even if ink leaks through the space between the outer peripheral surface 113 of the front portion 62 and the inner peripheral surface 502A of the atmospheric communication part 502 into the upper gap 375, the leaked ink is confined within the upper gap 375. For this reason, the ink leaked into the upper gap 375 is unlikely to flow inside the upper cap 55 through the space between the rear surface 352A of the upper contact portion 352 and the front surface 114 of the front portion 62. As a result, the ink in the ink reservoir chamber 46 is prevented from leaking externally through the atmospheric communication port 501.

In the above embodiment, the upper seal member 17 is positioned in the front-rear direction by the rear surface 112 of the rear portion 61 abutting the front end 511 of the upper support member 38. This makes it easier to assemble the upper seal member 17 to the inner peripheral surface 502A of the atmospheric communication part 502.

In the above embodiment, multiple inner ribs 38C are positioned at equal intervals along the circumferential direction of the upper support member 38 on the inner peripheral surface of the cylindrical body 38A of the upper support member 38. Therefore, the front surfaces of the multiple inner ribs 38C uniformly contact the rear surface 112 of the rear portion 61 of the upper seal member 17 along the circumferential direction of the upper support member 38. As a result, the upper seal member 17 is less likely to incline, making it difficult for ink in the ink reservoir chamber 46 to leak from the atmospheric communication port 501. Since the multiple inner ribs 38C are spaced apart in the circumferential direction of the upper support member 38, an air flow path is ensured within the internal space of the upper support member 38. The protruding ends of the multiple inner ribs 38C contact the protruding end of the contact piece 50B, making the upper valve 50 less likely to incline.

In the above embodiment, the outer peripheral surface 49A of the upper coil spring 49 contacts the protruding end surface 311 of multiple front spring support parts 38D. Therefore, the upper coil spring 49 is guided in the front-rear direction by the multiple front spring support parts 38D, making it less prone to inclining. As a result, the upper valve 50, which is urged by the upper coil spring 49, is less likely to incline and smoothly moves in the front-rear direction between the third closed position and the third open position.

In the above embodiment, the upper support member 38 is positioned in the front-rear direction by the rear surface 48 of the outer rib 38B contacting the upper rear stepped surface 502C of the atmospheric communication section 502. The rear surface 48 of the outer rib 38B and the upper rear stepped surface 502C of the atmospheric communication section 502 contact each other obliquely with respect to the front-rear direction. Therefore, ink in the ink reservoir chamber 46 is less likely to leak frontward through the space between the rear surface 48 of the outer rib 38B and the upper rear stepped surface 502C of the atmospheric communication section 502.

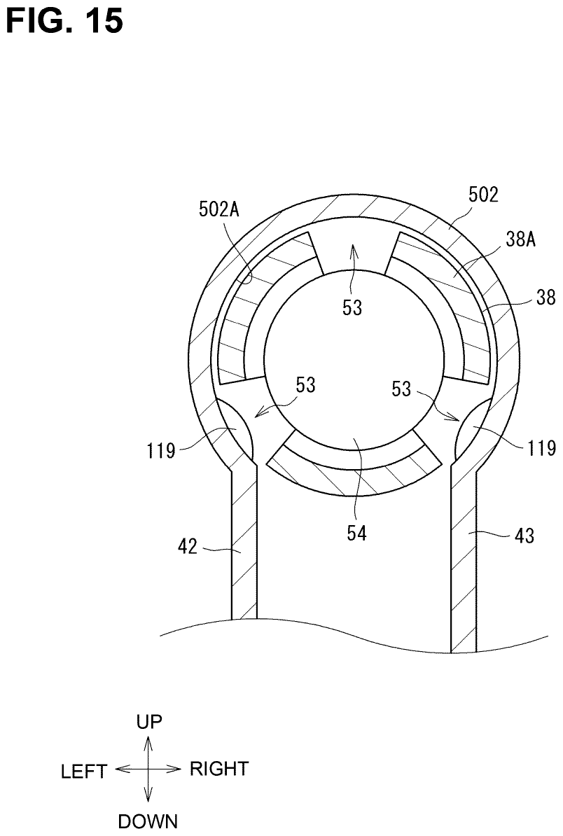

In the above embodiment, the container body 31 is formed by blow molding. Therefore, when the blow pin is screwed into the parison, a burr 119 may form on the inner peripheral surface 502A of the atmospheric communication section 502. In particular, as shown in FIG. 15, the burr 119 tends to form at a position 120 degrees around the atmospheric communication section 502 on the inner peripheral surface 502A.

In the above embodiment, the upper support member 38 has three slits 53 positioned at equal intervals in the circumferential direction. The three slits 53 connect the internal space of the cylindrical body 38A with the outside. The three slits 53 extend in the front-rear direction. Therefore, when a user inserts the upper support member 38 into the internal space of the atmospheric communication part 502, the three slits 53 allow avoidance of the flesh bulge 119. As a result, the user can easily insert the upper support member 38 into the internal space of the atmospheric communication part 502.

In the above embodiment, the upper support member 38 communicates the internal space of the cylindrical body 38A with the outside and has three slits 53 extending in the front-rear direction. Therefore, even if ink bubbles form on the liquid surface when ink is injected into the ink cartridge 30, those bubbles are easily eliminated by coming into contact with the three slits 53. As a result, printing defects caused by ink bubbles being sent to the recording head 21 are suppressed.

In the above embodiment, the lower ends 53A of the three slits 53 in the upper support member 38 of the ink cartridge 30 in the injection posture are positioned below the maximum liquid level L of the ink reservoir chamber 46. Therefore, bubbles generated on the liquid surface due to ink injection come into contact with the three slits 53 as the liquid level rises with the injection of ink. Consequently, the bubbles are likely to disappear easily.

In the above embodiment, when the ink cartridge 30 is not installed in the cartridge case 110, the temperature of the ink storage chamber 46 may rise. When the temperature of the ink storage chamber 46 rises, the air pressure inside the ink storage chamber 46 increases, exerting a frontward pushing force on the lower seal member 35. As a result, the position of the lower seal member 35 in the front-rear direction may shift backward. Consequently, the lower valve 36 may not fully close the lower through-hole 19, which could cause ink in the ink storage chamber 46 to leak from the ink outlet 34 to the outside.

In the above embodiment, the outer peripheral surface 123 of the lower contact portion 83 of the lower cap 39, which is located in front of the lower seal member 35, contacts the inner peripheral surface 124 of the front portion 35A of the lower seal member 35. As a result, the front portion 35A of the lower seal member 35 firmly adheres to the inner peripheral surface 33A of the ink supply section 33, making it difficult for the position of the lower seal member 35 to shift backward in the front-rear direction. Therefore, ink in the ink storage chamber 46 is less likely to leak from the ink outlet 34 to the outside.

In the above embodiment, the dissolved portion melted by the welding of the lower welding wall 81B flows into the lower gap 85. Therefore, when the lower welding wall 81B is welded to the inner peripheral surface 33A of the ink supply section 33, the lower cap 39 is prevented from deforming significantly.

### [Modification]

In the above embodiment, the first surface 371 of the upper cap 55 is a plane orthogonal to the front-rear direction. However, the first surface 371 may be slightly inclined with respect to the radial direction of the upper cap 55 so as to face slightly frontward as it moves inward in the radial direction of the upper cap 55. Alternatively, the first surface 371 may be slightly inclined with respect to the radial direction of the upper cap 55 so as to face slightly backward as it moves inward in the radial direction of the upper cap 55.

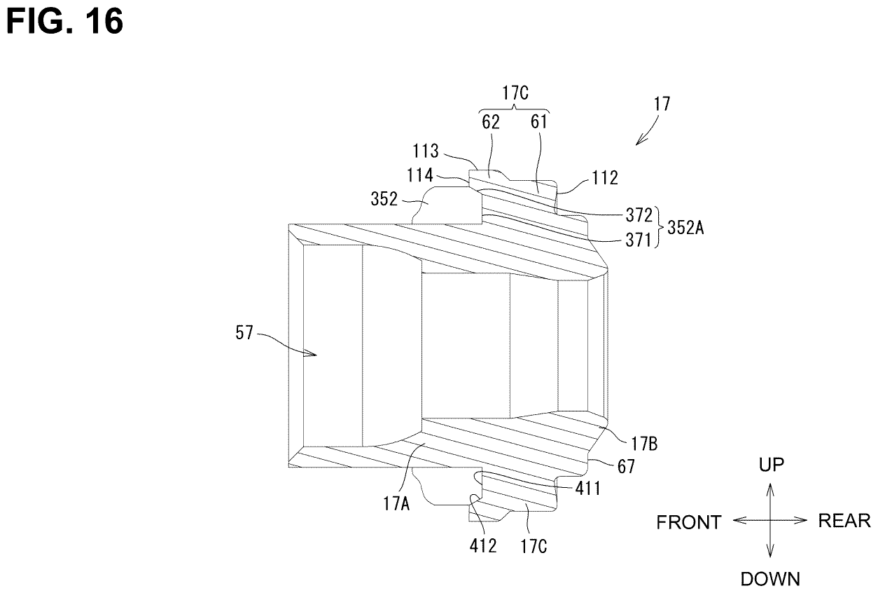

In the above embodiment, the front surface 114 of the front portion 62 of the upper seal member 17 is a plane orthogonal to the front-rear direction. However, as shown in FIG. 16, the front surface 114 of the front portion 62 of the upper seal member 17 may have a second surface 411 and a second inclined surface 412.

The second surface 411 is located on the inner peripheral portion of the front surface 114 of the front part 62. The second surface 411 is a plane orthogonal to the front-rear direction. The second surface 411 contacts the first surface 371 of the upper contact portion 352 in the front-rear direction.

The second inclined surface 412 is adjacent to the radially outer side of the upper seal member 17 on the second surface 411. The second inclined surface 412 is inclined in the radial direction of the upper seal member 17 so as to face frontward as it extends radially outward from the upper seal member 17. The second inclined surface 412 contacts the first inclined surface 372 of the upper contact portion 352 in the front-rear direction.

By doing this, the upper seal member 17 is more likely to receive a force from the first inclined surface 372 in the direction pressing the upper seal member 17 against the inner peripheral surface 502A of the atmospheric communication portion 502. Therefore, when the air pressure in the ink storage chamber 46 increases, the upper seal member 17 tends to adhere firmly to the inner peripheral surface 502A of the atmospheric communication portion 502.

In the above embodiment, the upper cap 55 is attached to the front end of the atmospheric communication part 502 by welding. However, as long as the upper cap 55 can be attached to the front end of the atmospheric communication part 502, the method of attaching the upper cap 55 is not limited. For example, the upper cap 55 may be attached to the atmospheric communication part 502 by adhesive.

In the above embodiment, an upper gap 375 exists between the outer peripheral surface 376 of the upper contact portion 352 and the inner peripheral surface 502A of the atmospheric communication portion 502. However, the upper gap 375 may be omitted. In this case, for example, the outer peripheral surface 376 of the upper contact portion 352 may contact the inner peripheral surface 502A of the atmospheric communication portion 502.

In the above embodiment, the rear surface 352A of the upper contact portion 352 of the upper cap 55 contacts the front surface 114 of the front part 62 of the upper seal member 17. However, if a part of the upper cap 55 contacts the upper seal member 17 from the front, the rear surface 352A of the upper contact portion 352 does not necessarily have to contact the front surface 114 of the front part 62.

In the above embodiment, the upper valve mechanism 504 includes an upper support member 38. However, the upper support member 38 may be omitted. In this case, the upper valve 50 and the upper coil spring 49 are supported by the inner peripheral surface 502A of the atmospheric communication part 502.

In the above embodiment, the multiple inner ribs 38C are positioned at equal intervals in the circumferential direction of the upper seal member 17 on the inner peripheral surface of the cylinder 38A. However, the multiple inner ribs 38C do not necessarily have to be positioned at equal intervals in the circumferential direction of the upper seal member 17 on the inner peripheral surface of the cylinder 38A.

In the above embodiment, the multiple inner ribs 38C contact the rear surface of the upper seal member 17 and the contact piece 50B of the upper valve 50. However, the multiple inner ribs 38C do not necessarily have to contact the rear surface of the upper seal member 17 and the contact piece 50B of the upper valve 50. Additionally, the multiple inner ribs 38C may be omitted.

In the above embodiment, the multiple front spring support parts 38D contact the outer peripheral surface 49A of the upper coil spring 49. However, the multiple front spring support parts 38D do not necessarily have to contact the outer peripheral surface 49A of the upper coil spring 49. Additionally, the multiple front spring support parts 38D may be omitted.

In the above embodiment, the cylindrical body 38A of the upper support member 38 has three slits 53. However, the cylindrical body 38A may have one or more slits 53. Furthermore, the three slits 53 may be omitted. In this case, for example, the rear end of the cylindrical body 38A may be open to the rear.

In the above embodiment, when the atmosphere communication port 501 is oriented upward in the injection posture, the lower ends 53A of the three slits 53 are positioned below the maximum liquid level L. However, the lower ends 53A of the three slits 53 may be positioned above the maximum liquid level L.

In the above embodiment, the lower valve 36 includes a first valve 36A and a second valve 36B. However, either the first valve 36A or the second valve 36B may be omitted.

In the above embodiment, a lower gap 85 exists between adjacent connecting pieces 82 in the circumferential direction of the lower cap 39. However, the lower gap 85 may be absent. In this case, multiple connecting pieces 82 may be continuous in the circumferential direction of the lower cap 39, for example.

What is claimed is:

1. A liquid cartridge configured to be inserted into a printer, the liquid cartridge comprising:
a housing having a first cylindrical portion that opens in a frontward, the frontward being toward which the liquid cartridge is inserted in a front-rear direction; and
a first valve mechanism, at least portion of the first valve mechanism being accommodated within the first cylindrical portion, wherein
the first valve mechanism includes:
a first seal member being in contact with an inner peripheral surface of the first cylindrical portion and, the first seal member having a first through hole;
a first valve being positioned inside the first cylindrical portion and the first valve being movable between a closed position at which the first valve closes the first through hole and an open position at which the first valve opens the first through hole;
a first biasing member biasing the first valve frontward such that the first valve biases toward the closed position; and
a first cap having an annular shape and the first cap being attached to the first cylindrical portion,
wherein the first cap has a first inclined surface having an annular shape,
wherein the first inclined surface is in contact with the first seal member from the frontward, and
wherein the first inclined surface is inclined with respect to a direction perpendicular to the front-rear direction such that the first inclined surface is positioned the frontward in the front-rear direction as the first inclined surface is positioned outward in the direction perpendicular to the front-rear direction.

2. The liquid cartridge according to claim 1, wherein
the first seal member has a second inclined surface being in contact with the first seal member from a rearward, and
the second inclined surface is inclined with respect to the direction perpendicular to the front-rear direction such that the second inclined surface is positioned frontward in the front-rear direction as the second inclined surface is positioned outward in the direction perpendicular to the front-rear direction.

3. The liquid cartridge according to claim 2, wherein
the first cap has a first surface positioned inward, which is opposite to the outward, with respect to the first inclined surface,
the first surface faces rearward and the first surface is in contact with the first seal member from the frontward,
the first seal member has a second surface positioned inward with respect to the second inclined surface,
the second surface faces frontward and the second surface is in contact with the first surface.

4. The liquid cartridge according to claim 1, wherein
the first cap includes:
a first cap body having an annular shape and the first cap body being welded to the inner peripheral surface of the first cylindrical portion; and
a first rib extending from the first cap body rearward in the front-rear direction, and the first inclined surface being positioned at a rear end of the first rib, and
an outer peripheral surface of the first rib and the inner peripheral surface of the first cylindrical portion define a gap therebetween.

5. The liquid cartridge according to claim 4, wherein
the first seal member includes:
a seal body having an annual shape and defining the first through hole; and
a first contact portion having an annual shape, the first contact portion extending outward from an outer peripheral surface of the seal body, and the first contact portion being in contact with the inner peripheral surface of the first cylindrical portion, and
wherein the rear end of the first rib is in contact with a front surface of the first contact portion from the frontward.

6. The liquid cartridge according to claim 5, wherein
the first valve mechanism further includes a support member having an annual shape, the support member extending in the front-rear direction within the first cylindrical portion, and the support member accommodates the first valve and the first biasing member, and
wherein the support member has a second contact portion being in contact with a rear portion of the first contact portion in the front-rear direction.

7. The liquid cartridge according to claim 6, wherein
the support member has a plurality of second ribs extending inward from a front end of an inner peripheral surface of the support member and positioned at equal intervals in a circumferential direction of the support member, and
the plurality of second ribs are in contact with a rear end of the first seal member and an outer peripheral surface of the first valve.

8. The liquid cartridge according to claim 7, wherein
the first biasing member is a coil spring compressible in the front-rear direction,
the support member has a plurality of third ribs positioned rearward of the plurality of second ribs, each of the plurality of the third ribs extending inward from the inner peripheral surface of the support member, and the plurality of the third ribs being positioned at equal intervals in the circumferential direction of the support member, and
wherein the plurality of third ribs are in contact with an outer peripheral surface of the coil spring.

9. The liquid cartridge according to claim 6, wherein
the inner peripheral surface of the first cylindrical portion has an annular stepped surface sloped inward in the front-rear direction as the stepped surface extends rearward,
wherein the support member has an annular outer rib protruding outward from an outer peripheral surface of the support member, and
wherein a rear surface of the outer rib is inclined in a direction orthogonal to the front-rear direction so as to face rearward as the rear surface of the outer rib extends inward and the rear surface is in contact with the stepped surface.

10. The liquid cartridge according to claim 6, wherein
the support member connects an internal space of the support member and an outside, and the support member has a slit that extends in the front-rear direction.

11. The liquid cartridge according to claim 10, wherein
in a state where the first cylindrical portion opens upwardly, a lower end of the slit is positioned below a maximum liquid level inside the housing when a maximum amount of liquid is injected.

12. The liquid cartridge according to claim 10, wherein
the slit includes three slits positioned at equal intervals in the circumferential direction of the support member.

13. A liquid cartridge configured to be inserted into a printer, the liquid cartridge comprising:
a housing having a second cylindrical portion that opens in a frontward, toward which the liquid cartridge is inserted in a front-rear direction; and
a second valve mechanism, at least portion of the second valve mechanism being accommodated within the second cylindrical portion, wherein
the second valve mechanism includes
a second seal member being in contact with an inner peripheral surface of the second cylindrical portion and having a second through hole,
a seal valve being positioned inside the second cylindrical portion and being movable between a closed position at which the second valve closes the second through hole and an open position at which the second valve opens the second through hole,
a second biasing member biasing the second valve frontward such that the second valve moves toward the closed position, and
a second cap being attached to the second cylindrical portion, positioned the frontward of the second seal member in the front-rear direction, and in contact with an inner peripheral surface of the second seal member.

14. The liquid cartridge according to claim 13, wherein
the second cap includes:
a second cap body having an annual shape and the second cap body being welded to the inner peripheral surface of the second cylindrical portion;
a third contact portion positioned backward of the second cap body in the front-rear direction and the third contact portion being in contact with the second sealing member; and
a plurality of connecting pieces connecting the second cap body and the third contact portion in the front-rear direction and the plurality of connecting pieces being positioned at intervals in a circumferential direction of the second cap.
